(19) United States
(12) Patent Application Publication
(10) Pub. No.: US 2022/0365906 A1
(43) Pub. Date: Nov. 17, 2022

(54) RESUMABLE COPY OPERATION

(71) Applicant: Apple Inc., Cupertino, CA (US)

(72) Inventors: Pavel CISLER, Redwood City, CA (US); Loic E. VANDEREYKEN, Palo Alto, CA (US)

(21) Appl. No.: 17/518,487

(22) Filed: Nov. 3, 2021

Related U.S. Application Data
(60) Provisional application No. 63/189,664, filed on May 17, 2021.

(51) Int. Cl. G06F 16/16; G06F 3/0484; G06F 3/06

(52) U.S. Cl. CPC G06F 16/168; G06F 16/164; G06F 3/04842; G06F 3/0647; G06F 3/0604; G06F 3/0683

(57) ABSTRACT

A method is provided that includes initiating a copy operation to copy a set of files from a source location on a first storage device to a destination location on a second storage device. Metadata is stored on the second storage device in association with the destination location to include the source location on the first storage device and an indication that the copy operation has been initiated. The metadata is updated with identifying information of files from the set of files successfully copied from the source location to the destination location during the copy operation. After an interruption in the copy operation, the copy operation is resumed based on the metadata identifying the source location of the set of files and the identified files successfully copied from the source location to the destination location prior to the interruption.

### CROSS-REFERENCE TO RELATED APPLICATIONS

This application claims the benefit of U.S. Provisional Application No. 63/189,664, filed on May 17, 2021, the entirety of which is incorporated herein by reference for all purposes.

### TECHNICAL FIELD

The present description relates generally to electronic file management, including managing the copying of electronic files from one location to another.

### BACKGROUND

Portable electronic storage devices provide a convenient mechanism to store and transport electronic files. The storage capacity of these devices is continually increasing, which allows more and larger files to be stored and transported. However, increasing storage capacity often translates into longer transfer times when copying files from an electronic storage device to another location such as a personal computer.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which the subject technology may operate in accordance with one or more implementations.

FIG. 2 is a block diagram illustrating components of a storage device in accordance with aspects of the subject technology.

FIG. 3 illustrates an example process for managing a copy operation according to aspects of the subject technology.

FIG. 4 illustrates a user interface according to aspects of the subject technology.

FIG. 5 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form to avoid obscuring the concepts of the subject technology.

Copy operations may be used to move a set of files, such as a folder containing multiple files, from a source location on a storage device to a destination location on the same storage device or on another storage device. For convenience, a single copy operation may be initiated to copy the set of files rather than the time-consuming manual process of initiating a separate copy operation for each file in the set. However, such a single copy operation may require a longer period of time to complete and therefore may be more susceptible to an interruption event preventing the operation from completing. If the copy operation is interrupted, the entire copy operation may need to be repeated from the beginning once the interruption event has been resolved.

The subject technology provides integrity of copy operations in situations where a copy operation is interrupted before completion without requiring the entire copy operation to be repeated after the interruption has been resolved. For example, upon initiation of a copy operation metadata may be maintained at a destination location during the copy operation. The metadata may include information on a source location for the copy operation and information on the state of the copy operation and, more particularly, an amount of the copy operation that had been completed up to the time of interruption. Using the metadata, the copy operation may be resumed to complete the transfer of files from the source location to the destination location without repeating the copying of files that were successfully copied prior to the interruption. Accordingly, processing time and resources may be preserved by allowing a copy operation to resume after an interruption rather than repeating the entire copy operation from the beginning.

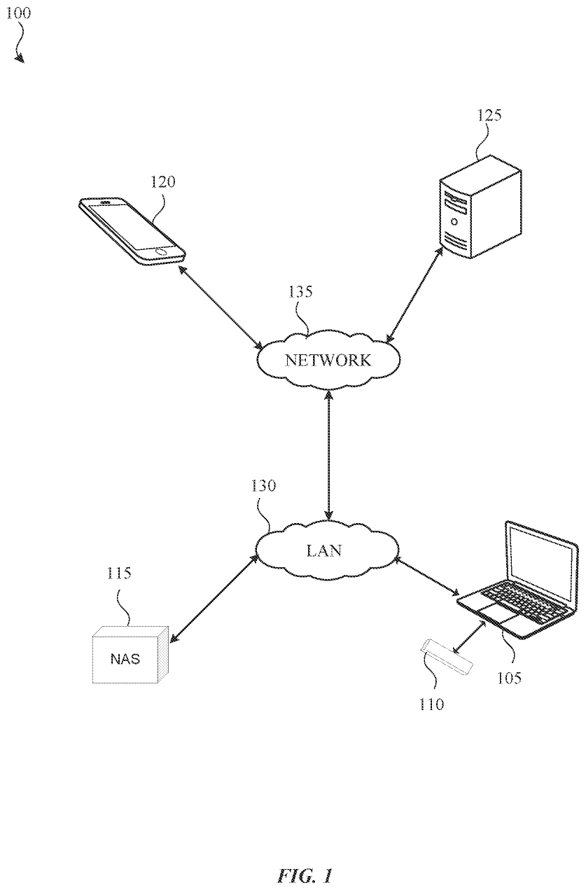

FIG. 1 illustrates an example network environment 100 in which the subject technology may operate in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated in FIG. 1, network environment 100 includes storage devices 105, 110, 115, 120, and 125 (hereinafter “storage devices 105-125”), local area network (LAN) 130, and network 135. In one or more implementations, LAN 130 may communicatively couple (directly or indirectly) storage devices 105 and 115 in a local network environment. Additionally, LAN 130 may communicatively couple (directly or indirectly) storage devices 105 and 115 to any of storage devices 120 and 125 via network 135. Storage device 110 may be directly communicatively coupled with storage device 105 using any wired or wireless technology that may communicatively couple two or more devices. For example, storage device 110 may be coupled with storage device 105 using a Universal Serial Bus (USB) connection, a FireWire connection, a Thunderbolt connection, etc.

In one or more implementations, LAN 130 may include one or more different network devices/network medium and/or may utilize one or more different wireless and/or wired network technologies, such as Ethernet, optical, Wi-Fi, Bluetooth, Zigbee, Powerline over Ethernet, coaxial, Ethernet, Z-Wave, cellular, or generally any wireless and/or wired network technology that may communicatively couple two or more devices. In one or more implementations, network 135 may be an interconnected network of devices that may include, and/or may be communicatively coupled to, the Internet.

For explanatory purposes, network environment 100 is illustrated in FIG. 1 as including storage devices 105-125; however, network environment 100 may include any number of storage devices. FIG. 1 illustrates storage device 105 as a laptop computer, storage device 110 as a portable hard drive or flash thumb drive, storage device 115 as network attached storage (NAS) device, storage device 120 as a smartphone, and storage device 125 as a server. The subject technology is not limited to these types or numbers of storage devices. For example, any of storage devices 105-125 may be a computing device such as a laptop computer, a smartphone, a set top box including a digital media player, a tablet device, or any other device that is capable of storing files and providing access to another device to copy those files to another device or accessing files on another device to copy those files from that device.

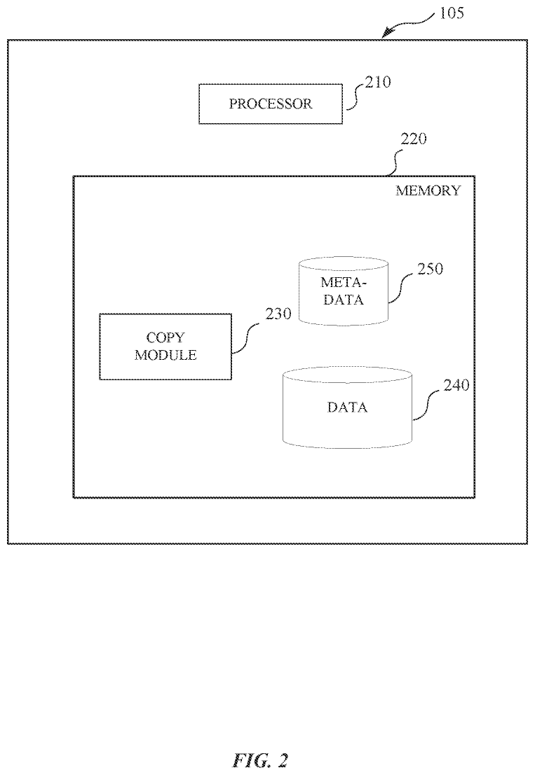

FIG. 2 is a block diagram illustrating components of a storage device in accordance with aspects of the subject technology. While FIG. 2 depicts components for storage device 105, FIG. 2 can correspond to any of storage devices 105-125 of FIG. 1. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In the example depicted in FIG. 2, storage device 105 includes processor 210 and memory 220. Processor 210 may include suitable logic, circuitry, and/or code that enable processing data and/or controlling operations of storage device 105. In this regard, processor 210 may be enabled to provide control signals to various other components of storage device 105. Processor 210 may also control transfers of data between various portions of storage device 105. Additionally, the processor 210 may enable implementation of an operating system or otherwise execute code to manage operations of storage device 105.

Processor 210 or one or more portions thereof, may be implemented in software (e.g., instructions, subroutines, code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices), and/or a combination of both.

Memory 220 may include suitable logic, circuitry, and/or code that enable storage of various types of information such as received data, generated data, code, and/or configuration information. Memory 220 may include, for example, random access memory (RAM), read-only memory (ROM), flash memory, and/or magnetic storage. As depicted in FIG. 2, memory 220 contains copy module 230, data 240, and metadata 250. The subject technology is not limited to these components both in number and type, and may be implemented using more components or fewer components than are depicted in FIG. 2.

According to aspects of the subject technology, copy module 230 comprises a computer program having one or more sequences of instructions or code together with associated data and settings. Upon executing the instructions or code, one or more processes are initiated to manage a copy operation to copy a set of files from a source location on a first storage device to a destination location on a second storage device. For example, storage device 105 may be communicatively coupled to another storage device and copy module 230 may manage a copy operation to copy a set of files located on the other storage device to data 240 section of memory 220.

As part of managing the copy operation, the one or more processes of copy module 230 also are configured to store and maintain metadata in metadata 250 of memory 220. The metadata may be stored in association with the destination location in data 240. For example, if a folder containing a set of files is selected for copying from a connected storage device, the metadata may be stored in association with the destination folder created in data 240 for the set of files to be copied. The metadata may be stored in the destination location or may be stored outside of the destination location and linked to the destination location.

The metadata contains information used by copy module 230 to resume a copy operation if the copy operation is interrupted prior to completion. The metadata may include, but is not limited to, the source location of the set of files to be copied, a copy status indicating that a copy operation has been initiated to copy the set of files to the destination location, and identifying information of files from the set of files for which the copy operation has been completed successfully. The source location may include a path to the location on the connected storage device. In addition to the path, other information such as a volume identifier, a path within a volume, and/or other data stored on the volume may be used to verify the source location as being the same source location as used when the copy operation was initiated. The identifying information of the files may be a file name or some other unique identifier assigned to the file. The identifying information also may include as access timestamp for the files. In some implementations, the identifying information may include identifying information for each file intended to be copied when the copy operation was initiated with an indicator as to which of the files were successfully copied.

As the copy operation progresses, the metadata is updated with identifying information of files for which the copy operation was completed successfully. Upon resuming the copy operation after an interruption, the identifying information may be used to identify those files in the set of files that copying does not need to be performed thereby avoiding wasteful recopying of files from the source location to the destination location. According to aspects of the subject technology, files from the set of files in the source location may be copied in chronological order based on the respective access timestamps associated with the individual files. In this manner, the access timestamp of the most recently copied file may be stored as the identifying information in the metadata. When a copy operation is resumed following an interruption, only those files having a later access timestamp need to be copied from the source location to the destination location to complete the copy operation. If one of the files that was previously copied has been updated during the interruption, the access timestamp will reflect the more recent activity with respect to the file and the need to copy the current version of the file to the destination location. A user may be given the option to keep the first version of the file copied or to overwrite the first version with the most recent version identified based on the access timestamp.

The metadata may be indexed in memory 220 of storage device 105. When another storage device is connected to storage device 105, the index may be referenced to determine if there are any copy operations between the connected storage device and storage device 105 that were interrupted. If interrupted copy operations are identified, the user of storage device 105 may be presented with the option to resume the copy operation(s).

The foregoing description has referenced files as the units of copying data from a source location to a destination location and the unit around which the metadata is organized. The subject technology is not limited to this unit of copying data and may be practiced with any type of data block that can be identified by location and for which access times are recorded.

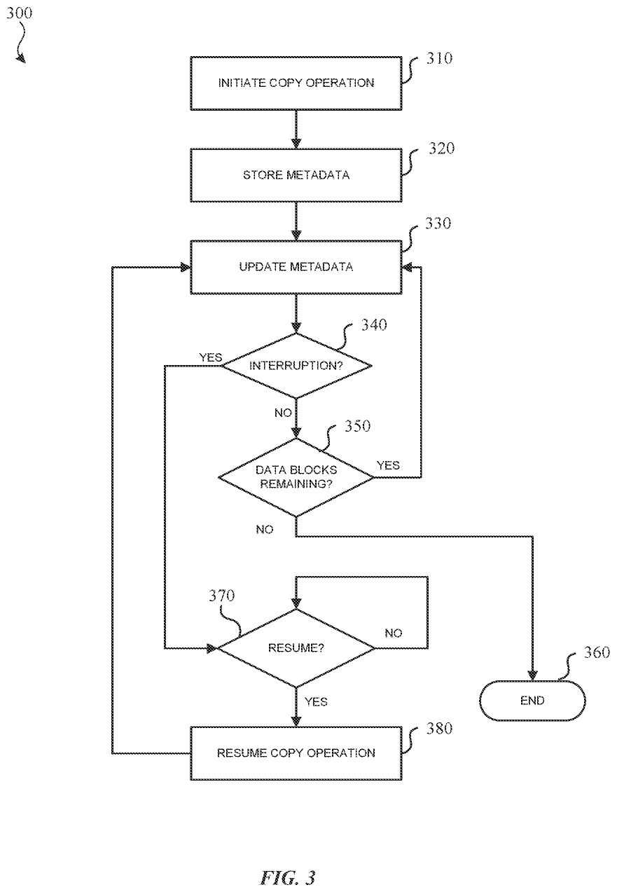

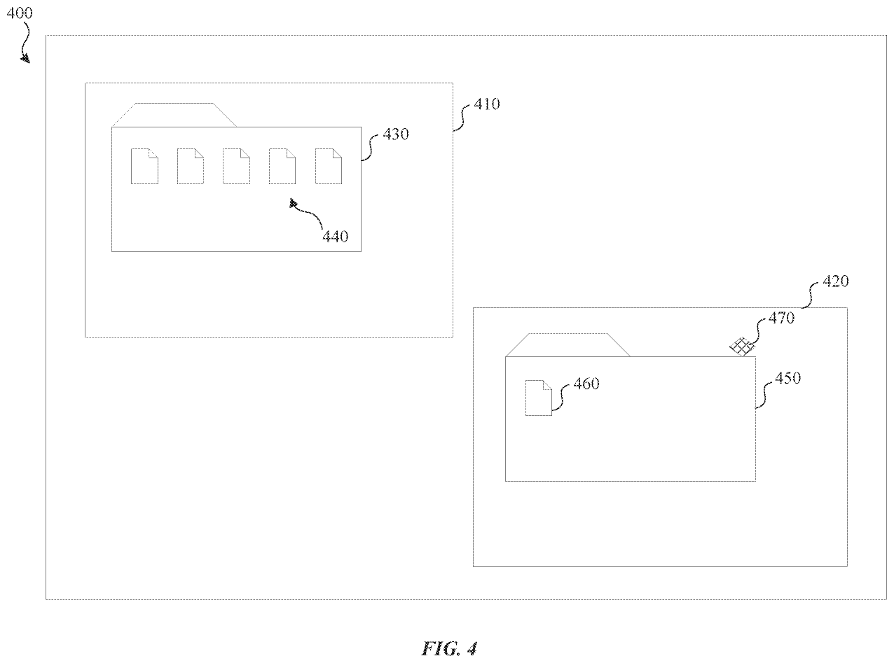

FIG. 3 illustrates an example process for managing a copy operation according to aspects of the subject technology. For explanatory purposes, the blocks of process 300 are described herein as occurring in serial, or linearly. However, multiple blocks of process 300 may occur in parallel. In addition, the blocks of process 300 need not be performed in the order shown and/or one or more blocks of process 300 need not be performed and/or can be replaced by other operations. Process 300 will be described with reference to FIG. 4, which illustrates a user interface according to aspects of the subject technology.

Example process 300 may be initiated upon a process in copy module 230 being executed on storage device 105 to initiate a copy operation to copy a set of data blocks from a source location on a connected storage device to a destination location on storage device 105 (block 310). With reference to FIG. 4, user interface 400 is shown displaying two windows, window 410 and window 420. Window 410 represents a source location on a connected storage device; the source location having a folder 430 with data blocks 440. Window 420 represents a destination location on storage device 105 having a folder 450 into which data blocks 440 will be copied as part of the copy operation. The copy process may be initiated by a user dragging and dropping folder 430 into window 420, and/or by using particular key combinations. Alternatively, the user may select a menu option to copy of contents of folder 430 by entering a path to folder 430 on the connected storage device and a path to the destination location of folder 450 on storage device 105. User interface element 470 may be displayed in association with folder 450 to indicate that folder 450 is the destination location for a pending copy operation. The subject technology is not limited to any particular graphical representation to communicate the pending copy operation associated with folder 450.

As part of the copy operation, process 300 stores metadata including the source location represented by folder 430 in window 410 and a copy status indicator to indicate that a copy operation to copy data blocks into folder 450 in window 420 is pending (block 320). This metadata may be stored in folder 450 or may be stored elsewhere in storage device 105 with a link to folder 450.

As data blocks are copied from the source location to the destination location, the metadata is updated with identifying information of the data blocks that have been copied successfully (block 330). Referring to FIG. 4, data block 460 represents a first data block from data blocks 440 in folder 430 that was copied successfully. After the copy operation for data block 460 has been completed, process 300 updates the metadata to identify the first data block of data blocks 440 as being successfully copied. As noted above, the identification may include a unique identifier and the last access timestamp associated with the first data block of data blocks 440. According to aspects of the subject technology, the metadata may be updated by adding the unique identifier and timestamp associated with the last data block successfully copied. Alternatively, the unique identifiers and timestamps for all of the data blocks to be copied may be added to the metadata at the beginning of the copy operation and a copy status indicator for each data block may be updated to reflect the data block having been copied successfully.

At any time during the copy operation, an interruption to the copy operation may occur (block 340). The interruption may be any event that prevents the copy operation from completing. For example, the connection (e.g., wired, wireless, via network, direct) with the connected storage device may be lost. Alternatively, power may be lost to one or both of the connected storage device and storage device 105. In some implementations, a displayed user interface element may be selected by a user to pause the copy operation.

In the absence of an interruption event, process 300 continues by determining if another data block remains to be copied from the source location (block 350). If another data block remains to be copied, process 300 returns to copy the data block and update the metadata to reflect the successful copying of the data block (block 330). If all of the data blocks requested to be copied in the copy operation have been copied successfully to the destination location, the copy operation ends (block 360). At the conclusion of the copy operation, the metadata associated with the destination location is updated to change the copy status indicator to indicate that the copy operation is complete. In addition, user interface element 470 may be removed from the displayed user interface.

In the case of an interruption event occurring, process 300 is put on hold until a request to resume the copy operation is received (block 370). User interface element 470 may remain displayed to indicate that the copy operation is incomplete and has been interrupted. User interface element 470 displayed during the interruption may be identical to what is displayed while the copy operation is pending and running, or interface element 470 may be changed to reflect, for example, the difference between a pending and running state and an interrupted state. The request to resume may be received by user selection of user interface element 470 or another user interface element displayed.

Upon receipt of a request to resume the copy operation, process 300 resumes the copy operation by examining the metadata associated with the destination location to determine which data blocks remain in the source location to be copied (block 380). In the interrupted state, user selection of user interface element 470 may trigger a selection menu to be displayed that provides options for cancelling the interrupted copy operation or resuming the copy operation. Cancelling the copy operation may include options to either leave the data blocks that were successfully copied to the destination location or to delete those data blocks. Other triggers may be employed to provide the user with options to resume or cancel the interrupted copy operation. For example, if the interruption was the result of a broken connection between the connected storage device and storage device 105, a menu with resuming options may be displayed to the user when the connection is restored. As noted above, the metadata associated with the destination location may be indexed on the storage device. According to aspects of the subject technology, that index may be checked whenever a storage device is connected to determine if there are any pending and interrupted copy operations for source locations on the connected storage device. If there is a hit in the index, the resume menu may be displayed for the user to select resumption or cancellation of that copy operation.

As noted above, the metadata may include a unique identifier and an access timestamp of the most recently copied data block. Accordingly, if data blocks are copied in chronological order based on the access timestamps, the next data block that needs to be copied upon resumption of the copy operation can be determined based on the last access timestamp recorded in the metadata and finding the next one among the uncopied data blocks in the source location. The next data block for copying may be a data block that was not copied prior to the interruption or may be a previously copied data block that was modified and therefore now has a later access timestamp. Once the next data block has been identified, process 300 continues by copying that data block and updating the metadata upon completion of the copy (block 330).

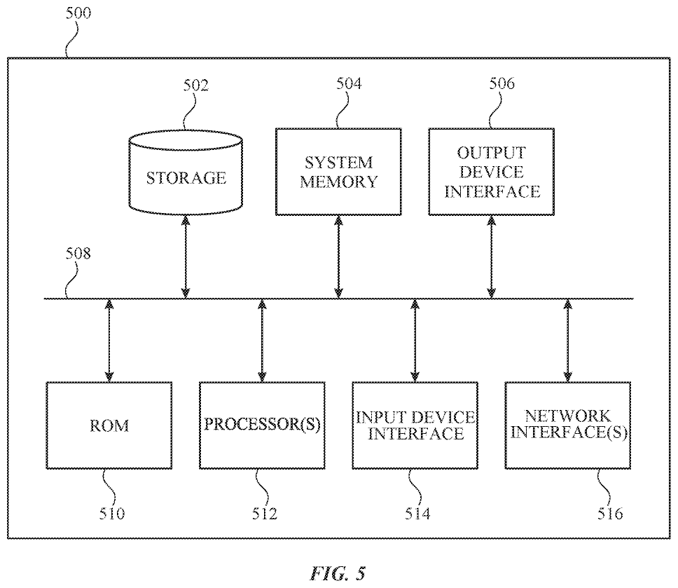

FIG. 5 illustrates an electronic system 500 with which one or more implementations of the subject technology may be implemented. Electronic system 500 can be, and/or can be a part of, one or more of storage devices 105-125 shown in FIG. 1. The electronic system 500 may include various types of computer readable media and interfaces for various other types of computer readable media. The electronic system 500 includes a bus 508, one or more processing unit(s) 512, a system memory 504 (and/or buffer), a ROM 510, a permanent storage device 502, an input device interface 514, an output device interface 506, and one or more network interfaces 516, or subsets and variations thereof.

The bus 508 collectively represents all system, peripheral, and chipset buses that communicatively connect the numerous internal devices of the electronic system 500. In one or more implementations, the bus 508 communicatively connects the one or more processing unit(s) 512 with the ROM 510, the system memory 504, and the permanent storage device 502. From these various memory units, the one or more processing unit(s) 512 retrieves instructions to execute and data to process in order to execute the processes of the subject disclosure. The one or more processing unit(s) 512 can be a single processor or a multi-core processor in different implementations.

The ROM 510 stores static data and instructions that are needed by the one or more processing unit(s) 512 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a floppy disk, flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random access memory. The system memory 504 may store any of the instructions and data that one or more processing unit(s) 512 may need at runtime. In one or more implementations, the processes of the subject disclosure are stored in the system memory 504, the permanent storage device 502, and/or the ROM 510. From these various memory units, the one or more processing unit(s) 512 retrieves instructions to execute and data to process in order to execute the processes of one or more implementations.

The bus 508 also connects to the input and output device interfaces 514 and 506. The input device interface 514 enables a user to communicate information and select commands to the electronic system 500. Input devices that may be used with the input device interface 514 may include, for example, alphanumeric keyboards and pointing devices (also called “cursor control devices”). The output device interface 506 may enable, for example, the display of images generated by electronic system 500. Output devices that may be used with the output device interface 506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 508 also couples the electronic system 500 to one or more networks and/or to one or more network nodes, such as the content provider 112 shown in FIG. 1, through the one or more network interface(s) 516. In this manner, the electronic system 500 can be a part of a network of computers (such as a LAN, a wide area network (“WAN”), or an Intranet, or a network of networks, such as the Internet. Any or all components of the electronic system 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

In accordance with the subject disclosure, a method is provided that includes initiating a copy operation to copy a set of files from a source location on a first storage device to a destination location on a second storage device. Metadata is stored on the second storage device in association with the destination location to include the source location on the first storage device and an indication that the copy operation has been initiated. The metadata is updated with identifying information of files from the set of files successfully copied from the source location to the destination location during the copy operation. After an interruption in the copy operation, the copy operation is resumed based on the metadata identifying the source location of the set of files and the identified files successfully copied from the source location to the destination location prior to the interruption.

A graphical representation of the destination location indicating pending completion of the copy operation after the copy operation is initiated may be provided for display by a computing device including the second storage device. The graphical representation of the destination location may be updated to indicate completion of the copy operation after the set of files has been copied from the source location to the destination location. An interface element associated with the destination location that indicates that the copy operation has been interrupted may be provided for display by the computing device. The interface element may be selectable and the copy operation may be configured to resume after selection of the interface element.

Presence of the first storage device containing the set of files at the source location may be confirmed based on the metadata stored on the second storage device in association with the destination location. The copy operation may resume after the interruption upon confirming the presence of the first storage device containing the set of files at the source location. The presence of the first storage device may be confirmed in response to selection of the interface element. The metadata may include a volume identifier for the first storage device and a path of the source location of the set of files on the first storage device.

The identifying information of the files successfully copied from the source location to the destination location may include an access timestamp of the file most recently successfully copied from the source location to the destination location. Files from the set of files may be copied in chronological order during the copy operation based on respective access timestamps of the files. The first storage device and the second storage device may be coupled to a single computing device. The first storage device may be coupled to a first computing device and the second storage device may be coupled to a second computing device, where the first computing device is in communication with the second computing device to perform the copy operation.

A non-transitory computer-readable medium is provided storing instructions which, when executed by one or more processors, cause the one or more processors to perform operations. The operations include initiating a copy operation to copy a set of files from a source location on a first storage device to a destination location on a second storage device and experiencing an interruption event that stops the copy operation before completion. The operations further include receiving an input to resume the copy operation and resuming, in response to the input, the copy operation based on metadata stored on the second storage device in association with the destination location.

The operations may further include providing, during the copy operation, a first interface element for display in association with the destination location on the second storage device, where the interruption event comprises a selection of the first interface element. The operations may further include providing, after the interruption event, a second interface element for display in association the destination location on the second storage device, where the input to resume comprises a selection of the second interface element. After the interruption event, a third interface element may be provided for display in association with the destination location on the second storage device. A selection of the third interface element may be received and a fourth interface element and a fifth interface element may be provided for display in response to the selection of the third interface element, where the input to resume the copy operation comprises a selection of the fourth interface element, and where the copy operation is stopped in response to a selection of the fifth interface element.

A device is provided that includes a memory storing a plurality of computer programs and one or more processors configured to execute instructions of the plurality of computer programs. The instructions are executed to initiate a copy operation to copy a set of data blocks from a source location on a first storage device to a destination location in the memory, wherein data blocks from the set of data blocks are copied in chronological order during the copy operation based on respective access timestamps of the data blocks. The instructions are executed to further store metadata in the memory in association with the destination location to include the source location on the first storage device and an indication that the copy operation has been initiated, and update the metadata with identifying information of data blocks from the set of data blocks successfully copied from the source location to the destination location during the copy operation, wherein the identifying information comprises an access timestamp of the data block most recently successfully copied from the source location to the destination location. After an interruption in the copy operation, the copy operation is resumed based on the metadata identifying the source location of the set of data blocks and the identified data blocks successfully copied from the source location to the destination location prior to the interruption.

The one or more processors may be further configured to execute instructions to provide for display a graphical representation of the destination location indicating pending completion of the copy operation after the copy operation is initiated, and update the graphical representation of the destination location to indicate completion of the copy operation after the set of data blocks has been copied from the source location to the destination location. The one or more processors may be further configured to execute instructions to provide for display an interface element associated with the destination location that indicates that the copy operation has been interrupted, where the interface element is selectable and the copy operation is configured to resume after selection of the interface element.

The one or more processors may be further configured to execute instructions to confirm a presence of the first storage device containing the set of data blocks at the source location based on the metadata stored in the memory in association with the destination location, where the copy operation resumes after the interruption upon confirming the presence of the first storage device containing the set of data blocks at the source location. The presence of the first storage device may be confirmed in response to selection of the interface element. The metadata may include a volume identifier for the first storage device and a path of the source location of the set of data blocks on the first storage device.

As described herein, aspects of the subject technology may include the collection and transfer of data from one computing device to other computing devices. The present disclosure contemplates that in some instances, this collected data may include personal information data that uniquely identifies or can be used to identify a specific person. Such personal information data can include demographic data, location-based data, online identifiers, telephone numbers, email addresses, home addresses, images, data or records relating to a user's health or level of fitness (e.g., vital signs measurements, medication information, exercise information), date of birth, or any other personal information.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of video conferencing, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an storage device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
initiating a copy operation to copy a set of files from a source location on a first storage device to a destination location on a second storage device;
storing metadata on the second storage device in association with the destination location to include the source location on the first storage device and an indication that the copy operation has been initiated;
updating the metadata with identifying information of files from the set of files successfully copied from the source location to the destination location during the copy operation; and
after an interruption in the copy operation, resuming the copy operation based on the metadata identifying the source location of the set of files and the identified files successfully copied from the source location to the destination location prior to the interruption.

2. The method of claim 1, further comprising:
providing for display by a computing device comprising the second storage device a graphical representation of the destination location indicating pending completion of the copy operation after the copy operation is initiated; and
updating the graphical representation of the destination location to indicate completion of the copy operation after the set of files has been copied from the source location to the destination location.

3. The method of claim 2, further comprising:
providing for display by the computing device an interface element associated with the destination location that indicates that the copy operation has been interrupted,
wherein the interface element is selectable and the copy operation is configured to resume after selection of the interface element.

4. The method of claim 3, further comprising:
confirming presence of the first storage device containing the set of files at the source location based on the metadata stored on the second storage device in association with the destination location,
wherein the copy operation resumes after the interruption upon confirming the presence of the first storage device containing the set of files at the source location.

5. The method of claim 4, wherein the presence of the first storage device is confirmed in response to selection of the interface element.

6. The method of claim 4, wherein the metadata comprises a volume identifier for the first storage device and a path of the source location of the set of files on the first storage device.

7. The method of claim 1, wherein the identifying information of the files successfully copied from the source location to the destination location comprises an access timestamp of the file most recently successfully copied from the source location to the destination location.

8. The method of claim 7, wherein files from the set of files are copied in chronological order during the copy operation based on respective access timestamps of the files.

9. The method of claim 1, wherein the first storage device and the second storage device are coupled to a single computing device.

10. The method of claim 1, wherein the first storage device is coupled to a first computing device and the second storage device is coupled to a second computing device, and
wherein the first computing device is in communication with the second computing device to perform the copy operation.

11. A non-transitory computer-readable medium storing instructions which, when executed by one or more processors, cause the one or more processors to perform operations comprising:
initiating a copy operation to copy a set of files from a source location on a first storage device to a destination location on a second storage device;
experiencing an interruption event that stops the copy operation before completion;
receiving an input to resume the copy operation; and
resuming, in response to the input, the copy operation based on metadata stored on the second storage device in association with the destination location.

12. The non-transitory computer-readable medium of claim 11, wherein the operations further comprise:
providing, during the copy operation, a first interface element for display in association with the destination location on the second storage device,
wherein the interruption event comprises a selection of the first interface element.

13. The non-transitory computer-readable medium of claim 12, wherein the operations further comprise:
providing, after the interruption event, a second interface element for display in association the destination location on the second storage device,
wherein the input to resume comprises a selection of the second interface element.

14. The non-transitory computer-readable medium of claim 12, wherein the operations further comprise:
providing, after the interruption event, a third interface element for display in association with the destination location on the second storage device;
receiving a selection of the third interface element; and
providing a fourth interface element and a fifth interface element for display in response to the selection of the third interface element,
wherein the input to resume the copy operation comprises a selection of the fourth interface element, and
wherein the copy operation is stopped in response to a selection of the fifth interface element.

15. A device, comprising:
a memory storing:
a plurality of computer programs; and
one or more processors configured to execute instructions of the plurality of computer programs to:
initiate a copy operation to copy a set of data blocks from a source location on a first storage device to a destination location in the memory, wherein data blocks from the set of data blocks are copied in chronological order during the copy operation based on respective access timestamps of the data blocks;
store metadata in the memory in association with the destination location to include the source location on the first storage device and an indication that the copy operation has been initiated;
update the metadata with identifying information of data blocks from the set of data blocks successfully copied from the source location to the destination location during the copy operation, wherein the identifying information comprises an access timestamp of the data block most recently successfully copied from the source location to the destination location; and
after an interruption in the copy operation, resume the copy operation based on the metadata identifying the source location of the set of data blocks and the identified data blocks successfully copied from the source location to the destination location prior to the interruption.

16. The device of claim 15, the one or more processors further configured to execute instructions to:
provide for display a graphical representation of the destination location indicating pending completion of the copy operation after the copy operation is initiated; and
update the graphical representation of the destination location to indicate completion of the copy operation after the set of data blocks has been copied from the source location to the destination location.

17. The device of claim 16, the one or more processors further configured to execute instructions to:
provide for display an interface element associated with the destination location that indicates that the copy operation has been interrupted,
wherein the interface element is selectable and the copy operation is configured to resume after selection of the interface element.

18. The device of claim 17, the one or more processors further configured to execute instructions to:
confirm a presence of the first storage device containing the set of data blocks at the source location based on the metadata stored in the memory in association with the destination location,
wherein the copy operation resumes after the interruption upon confirming the presence of the first storage device containing the set of data blocks at the source location.

19. The device of claim 18, wherein the presence of the first storage device is confirmed in response to selection of the interface element.

20. The device of claim 19, wherein the metadata comprises a volume identifier for the first storage device and a path of the source location of the set of data blocks on the first storage device.
